(19) United States
(12) Patent Application Publication
(10) Pub. No.: US 2015/0322672 A1
(43) Pub. Date: Nov. 12, 2015

(54) PLUG AND PLAY MODULAR COMFORT DEVICE AND INTERFACE TEMPLATE ADAPTED TO SAID PLUG AND PLAY MODULAR COMFORT DEVICE

(71) Applicants: Sridhar Deivasigamani, Peoria, IL (US); Sivaprasad Akasam, Dunlap, IL (US)

(72) Inventors: Sridhar Deivasigamani, Peoria, IL (US); Sivaprasad Akasam, Dunlap, IL (US)

(21) Appl. No.: 14/705,505

(22) Filed: May 6, 2015

Related U.S. Application Data
(60) Provisional application No. 61/989,087, filed on May 6, 2014.

(51) Int. Cl. E04B 2/00; H02G 3/36

(52) U.S. Cl. CPC E04B 2/00; H02G 3/36

(57) ABSTRACT

A modular interface template configured to receive a plug and play comfort device, the modular interface template including a wall having a first surface and a second surface, an air inlet channel configured to enable air flow from the first surface to the second surface, an air outlet channel configured to enable air flow from the second surface to the first surface, a gas conduit configured to supply fuel from the first surface to the second surface, a water inlet conduit configured to enable water flow from the first surface to the second surface, a water outlet conduit configured to enable water flow from the second surface to the first surface and a first electric power conductor configured to enable electric power transmission from the first surface to the second surface.

### PRIORITY CLAIM AND RELATED APPLICATIONS

This non-provisional application claims the benefit of priority from provisional application U.S. Ser. No. 61/989,087 filed on May 6, 2014. Said application is incorporated by reference in its entirety.

### BACKGROUND OF THE INVENTION

1. The Field of the Invention

The present invention is directed generally to a modular comfort device and an interface template adapted to receive the modular comfort device. More specifically, the present invention is directed to a plug and play modular comfort device including services such as a Heating, Ventilating and Air Conditioning (HVAC) device, a humidifier and the like and an interface template adapted to the plug and play modular comfort device.

2. Background Art

U.S. Pat. Pub. No. 2013/0014451 of Russell et al. discloses a prefabricated integrated utilities building core including a floor diaphragm, four walls connected to the floor diaphragm, and a utilities access corridor, and a method of constructing a building using the same. The floor diaphragm and the four walls form an interior of the prefabricated integrated utilities building core. The utilities access corridor has at least one access wall with a passage configured to provide access to and from the utilities access corridor from the interior of the prefabricated integrated utilities building core. There are a plurality of integrated utilities arranged within the prefabricated integrated utilities building core so as to be fully accessible from within the utilities access corridor. The utilities access corridor also includes an in-floor access hatch arranged to provide access to an in-floor portion of at least the plumbing of the plurality of integrated utilities. As the building core is disposed within the internal space of a building, access to it requires access to the interior of a building. Also, as the building core is of a substantial size, removal or replacement of it requires dismantlement of the building core.

Thus, there is a need for a comfort device that can be installed or serviced without requiring access to the interior of a building and one which can be installed by simply “dropping in” the comfort device as the infrastructure required to be connected to the comfort device is provided at an interface template adapted to the plug and play modular comfort device.

### SUMMARY OF THE INVENTION

In accordance with the present invention, there is provided a modular interface template configured to receive a plug and play comfort device, the modular interface template including a wall having a first surface and a second surface, an air inlet channel configured to enable air flow from the first surface to the second surface, an air outlet channel configured to enable air flow from the second surface to the first surface, a gas conduit configured to supply fuel from the first surface to the second surface, a water inlet conduit configured to enable water flow from the first surface to the second surface, a water outlet conduit configured to enable water flow from the second surface to the first surface and a first electric power conductor configured to enable electric power transmission from the first surface to the second surface.

In one embodiment, the present modular interface template further includes a second electric power conductor connecting the second surface and the first surface, where the second electric power conductor is configured to enable electric power transmission from the second surface to the first surface.

In one embodiment, the present modular interface template further includes a comfort device having an air heater configured to receive air flow supplied at the second surface by the air inlet channel and add heat to the air flow and send the air flow to the first surface at the air outlet channel.

In one embodiment, the present modular interface template further includes a comfort device having a water heater configured to receive water flow supplied at the second surface by the water inlet conduit and add heat to the water flow and send the water flow to the first surface at the water outlet conduit.

In one embodiment, the present modular interface template further includes a comfort device having an air chiller configured to receive air flow supplied at the second surface by the air inlet channel and remove heat to the air flow and send the air flow to the first surface at the air outlet channel.

In one embodiment, the present modular interface template further includes a comfort device comprising a humidifier configured to receive a portion of water flow supplied at the second surface by the water inlet conduit and supply moisture corresponding to the portion of water flow into the air outlet channel.

In one embodiment, the present modular interface template further includes a communication conduit from the first surface to the second surface, where the communication conduit is configured to receive communication connection at the second surface.

An object of the present invention is to provide a comfort device mountable and serviceable outside of a space within which the comfort device is configured to service where the space is contained in a building. In order to mount a comfort device mountable from the outside of the space, a modular interface template is provided where the modular interface template is configured to be mounted on a wall of the building or the modular interface template itself doubles as a wall or a portion of a wall configured to receive infrastructure such as air ducts, water pipes, gas line and electric wiring, etc.

Another object of the present invention is to provide a comfort device that is plug and play and easily swappable even by unskilled installation personnel.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top perspective view of a building, depicting the use of a present comfort device.

FIG. 2 is a partially transparent side orthogonal sectional view of a present interface template and a present comfort device adapted to the present interface template.

FIG. 3 is a partially transparent top perspective view of a present interface template.

### PARTS LIST

2—interface template
4—air intake port with outdoor temperature sensor
6—air inlet channel
8—air outlet channel
10—flue exhaust port
12—condensate drain port
14—solar panel
16—building serviced by comfort device
18—plug and play comfort device
20—wall where plug and play comfort device is mounted
22—communication conduit
24—water inlet conduit
26—water outlet conduit
28—gas conduit
30, 32—electric power conductor
34—first surface
36—second surface
38—lip
40—fastener
42—air heater/furnace and/or air conditioner/chiller
44—water heater
46—enclosure
48—humidifier

### PARTICULAR ADVANTAGES OF THE INVENTION

The present interface template is provided to facilitate the installation of a plug and play comfort device including at least one, but not limited to, one of the following appliances: a water heater, an air heater and a humidifier.

The present interface template is provided to facilitate the installation of a plug and play comfort device on the exterior of a building such that the comfort device is accessible for maintenance or replacement from the exterior of the building without requiring access to the interior of the building.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). The terms “inlet” and “outlet” are used herein to reference the direction in which a resource, e.g., air or water, flows with respect to the wall of a building such resource flows through. For instance, a resource flowing into a building through the wall or interface template is considered an “inlet” flow while a resource flowing out of a building through the wall or interface template is considered an “outlet” flow.

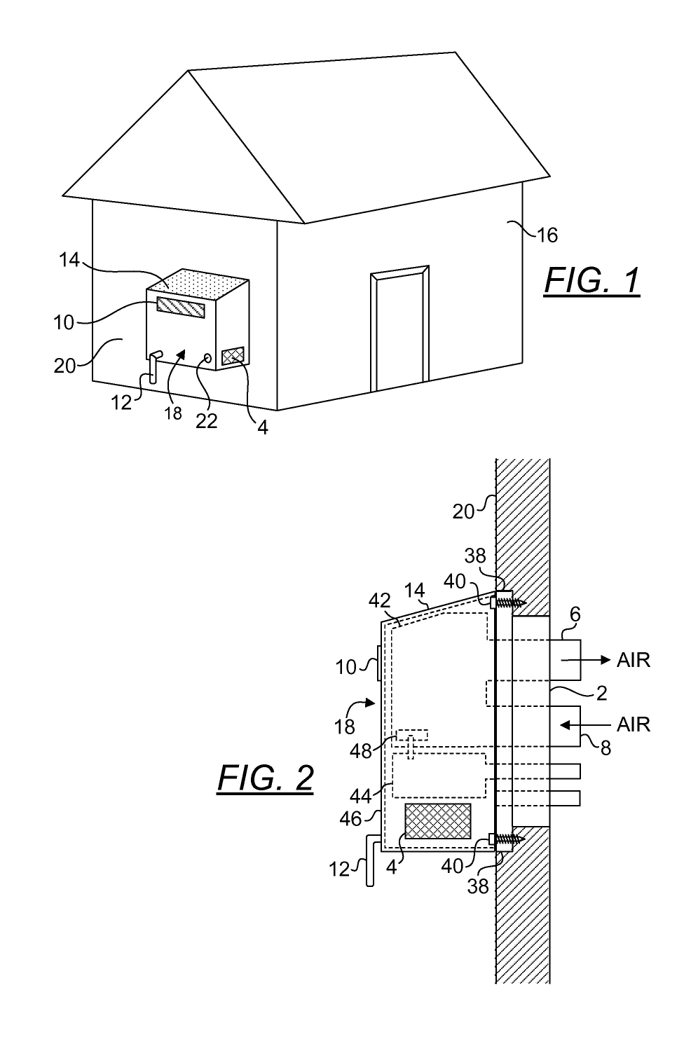

FIG. 1 is a top perspective view of a building 16, depicting the use of a present comfort device 18. The present comfort device 18 and its modular interface template 2 are preferably taken into consideration during the planning and construction of a building as such activities can result in favorable placements of utilities connecting points to the modular interface template 2. It is also possible to modify an existing building to replace existing conventional comfort devices. If modification is chosen, the wall at which a present comfort device will be mounted is preferably a wall or an extension of a wall (if the existing conventional comfort device is mounted in a basement) on the first floor. A first floor mount enables simple, elevation equipment-free mounting.

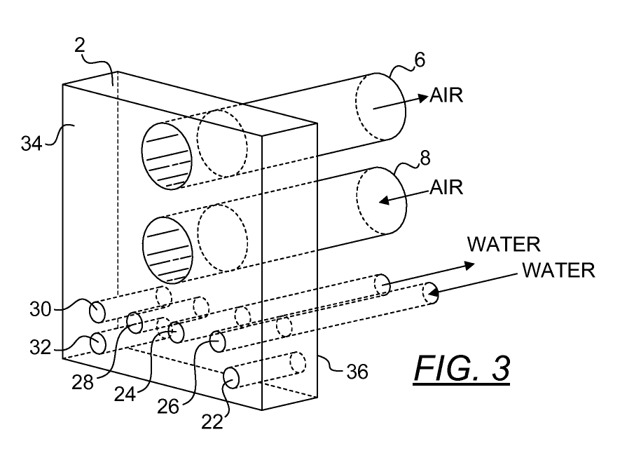

FIG. 2 is a partially transparent side orthogonal sectional view of a present interface template 2 and a present comfort device 18 adapted to the present interface template 2. It is to be understood that whereas only a furnace 42, a water heater 44 and a humidifier 48 are depicted therein, there is no intention to limit the invention to these devices. All devices are however preferably contained within an enclosure 46 for protection and neat appearance. FIG. 3 is a partially transparent top perspective view of a present interface template 2. A modular interface template 2 is configured to receive a plug and play comfort device 18. The modular interface template 2 includes a wall having a first surface 34 and a second surface 36, an air inlet channel 6, an air outlet channel 8, a gas conduit 28, a water inlet conduit 24, a water outlet conduit 26, a first electric power conductor 30 and a second electric power conductor 32. The modular interface template 2 may be removably secured to the wall 20 via one of several common construction techniques. In one embodiment, the modular interface template 2 does not include a gas conduit 28 as all components of the comfort device 18 which require power are electrically driven. Alternatively, when not in use, any facilities including a gas conduit 28 of the interface template 2 may be plugged to avoid intrusions of pests. Wall 20 may be constructed such that an opening is left in the wall 20 so that a modular interface template 2 can be inserted in the opening and secured to the wall 20 via common fastening techniques such as screwing the modular interface template 2 into the periphery of the opening. Where appropriate, steel or wood studs may be used to frame the opening, thereby providing a sturdy frame onto which a modular interface template 2 can be secured via common fastening techniques. In the embodiment shown in FIG. 2, a lip 38 is further disposed around the second surface of the modular interface template 2 and an appropriate offset complementary to the lip 38 is disposed on the frame to receive the lip 38. Fasteners 40, e.g., screws are used to secure the modular interface template 2 at the lip 38 to the frame.

The air inlet channel 6 connects the first surface 34 and the second surface 36, where the air inlet channel 6 is configured to enable air flow from the first surface 34 to the second surface 36. An air heater or furnace is provided in the comfort device 18 to receive return air from within the building through air outlet channel 8. The air outlet channel 8 connects the second surface 36 and the first surface 34, where the air outlet channel is configured to enable air flow from the second surface 36 to the first surface 34. The gas conduit 28 connects the first surface 34 and the second surface 36, where the gas conduit 28 is configured to supply fuel from the first surface 34 to the second surface 36. The water inlet conduit 24 connects the first surface 34 and the second surface 36, where the water inlet conduit 24 is configured to enable water flow from the first surface 34 to the second surface 36. The water outlet conduit 26 connects the second surface 36 and the first surface 34, where the water outlet conduit 26 is configured to enable water flow from the second surface 36 to the first surface 34. The first electric power conductor 30 connects the first surface 34 to the second surface 36, where the first electric power conductor 30 is configured to enable electric power transmission from the first surface 34 to the second surface 36.

Upon installation of the modular interface template 2, it is now ready to receive various services from the building interior. A supply air duct is connected to the air inlet channel 6 on the first surface 34. A return air duct is connected to the air outlet channel 8 on the second surface 36. A blower-equipped air heater may be provided in the comfort device 18 to heat the air drawn into the air heater through air outlet channel 8. Heated air is returned via the air inlet channel 6 to the supply air duct to the interior of the building. Ambient air (or make-up air) may also be drawn through an air intake port 4 on the comfort device 18 and subsequently mixed with the return air to be heated and sent to the return air duct. A water supply line is connected to the water inlet conduit 24 where a supply of unheated water is available. A water heater may be provided in the comfort device 18 to heat the water supplied via the water outlet conduit 26. A water supply line is connected to the water inlet conduit 24 where a supply of heated water is sent to various points of usage of the building 16. A gas supply line is connected to the gas conduit 28 where a supply of fuel, e.g., natural gas, propane, etc., is fed into a device requiring the fuel, e.g., a water heater, an air heater and the like. An air chiller may be provided in the comfort device 18 to chill the air drawn in via the air outlet channel 8 and ambient air through the air intake port 4. A humidifier may be provided in the comfort device 18 where a supply of water is again obtained via the water outlet conduit 26. Runoffs from the humidifier may be discharged directly into a condensate drain 12 which also drains condensations from any one of the air heater, water heater and air chiller. A communication conduit 22 connecting the first surface 34 and the second surface 36 may be provided to enable one or more communication, e.g., ethernet cables, etc. to be routed through the conduit from the interior space of the building 16. In another embodiment, the comfort device 18 includes an on-board wireless communication controller and therefore does not require a physical communication cable. In yet another embodiment, a communication cable may be made available outside of the building 16 and can therefore be connected directly to the comfort device 18. Also disclosed is a first electric power conductor 30 connecting the first surface 34 to the second surface 36, where the first electric power conductor is configured to enable electric power transmission from the first surface 34 to the second surface 36. This electric power conductor 30 enables the comfort device 18 to receive power such that any appliances requiring electric power may be powered. In one embodiment, a second electric power conductor 32 may be provided to allow flow of excess electrical power to be sent back into the building, e.g., in the case where a solar panel 14 is used to generate electricity. In this embodiment, the energy collected from the solar panel 14 may also be stored locally in a battery disposed within the comfort device 18 or in a location in the building 16. Although the capacity of such storage may not be sufficient to power the appliances and their corresponding controllers for an extended amount of time, it may be used to power the appliances during power outages. In one embodiment, one or more fuel cell units are provided to generate electric power. A by-product of such units comes in the form of heat which may in turn be used to power a heat pump to provide heating or cooling. Alternatively or additionally, electrical conduits may be made available instead such that electrical wires may be routed through such conduits. A flue exhaust port 10 is configured to channel all flue gases as a result of combustion and other waste by-products out of the comfort device 18. Care shall be taken to ensure that the flue exhaust port 10 not be disposed adjacent the air intake port 4 so that no flue gas is pulled directly back into the building through the air intake port 4. The flue exhaust port 10 may alternatively be extended upwardly to create an even greater distance between the flue exhaust port 10 and the air intake port 4.

In one embodiment, the direction of air flow may be reversed to normalize the temperatures of serviced space, i.e., the air outlet channel 8 now serves as an air supply path into the space of the building 16 while the air inlet channel 6 serves as an air path to the comfort device 18. In typical building construction practices where air supply and return ducts are made available, the ducts are spatially disposed in opposite ends. For instance, if the supply ducts empty heated or cooled air into a space near the bottom of a wall, the return duct is typically disposed near the top of a wall disposed in the opposite side of the space. The intent is to have the circulated air traverse the space as much as possible. The ability to reverse air flow enables cold air to be forced into a space from the vents disposed at the top of the space while warm air is forced via vents into the space from the bottom of the space. As cold air sinks and warm air rises, the ability to force air into a space and draw air from the space at suitable locations enables traversal of the forced air through the entire space, removing stratification of the volume of air in the space and making the space more comfortable for its occupant. Care shall be taken to ensure that, if air filters are used, that the air filters be reversed to anticipate the change in air flow direction.

In one embodiment, one or more appliances of the group of appliances are modular. Therefore, it is possible to replace only one appliance within a device and not the device itself if not all of the appliances need replacement or repair. As each appliance is modular, a faulty appliance may be removed for repair while an interim replacement can be installed to ensure continued services are provided or to cut down on downtime while repairs are performed.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A modular interface template 2 configured to receive a plug and play comfort device 18, said modular interface template 2 comprising:
(a) a wall having a first surface 34 and a second surface 36;
(b) an air inlet channel 6 connecting said first surface 34 and said second surface 36, wherein said air inlet channel 6 is configured to enable air flow between said first surface 34 and said second surface 36;
(c) an air outlet channel 8 connecting said second surface 36 and said first surface 34, wherein said air outlet channel 8 is configured to enable air flow between said second surface 36 and said first surface 34;
(d) a water inlet conduit 24 connecting said first surface 34 and said second surface 36, wherein said water inlet conduit 24 is configured to enable water flow from said first surface 34 to said second surface 36; and
(e) a water outlet conduit 26 connecting said second surface 36 and said first surface 34, wherein said water outlet conduit 26 is configured to enable water flow from said second surface 36 to said first surface 34.

2. The modular interface template 2 of claim 1, further comprising at least one electric power conductor 30, 32 connecting said second surface 36 and said first surface 34, wherein said at least one electric power conductor 30, 32 is configured to enable electric power transmission between said second surface 36 and said first surface 34.

3. The modular interface template 2 of claim 1, further comprising a comfort device 18 comprising an air heater 42 configured to receive air flow supplied at said first surface 34 by said air outlet channel 8 and add heat to said air flow and send the air flow to said second surface 36 at said air inlet channel 6.

4. The modular interface template 2 of claim 1, further comprising a comfort device 18 comprising an air chiller 42 configured to receive air flow supplied at said first surface 34 by said air outlet channel 8 and remove heat from said air flow and send the air flow to said second surface 36 at said air inlet channel 6.

5. The modular interface template 2 of claim 1, further comprising a comfort device 18 comprising a water heater 44 configured to receive water flow supplied at said first surface 34 by said water outlet conduit 26 and add heat to the water flow and send the water flow to said second surface 36 at said water inlet conduit 24.

6. The modular interface template 2 of claim 1, further comprising a comfort device 18 comprising a humidifier 48 configured to receive a portion of water flow supplied at said first surface 34 by said water outlet conduit 26 and supply moisture derived from the portion of water flow into said air inlet channel 6.

7. The modular interface template 2 of claim 1, further comprising a communication conduit 22 between said first surface 34 and said second surface 36, wherein said communication conduit 22 is configured to receive a communication connection at said first surface 34.

8. The modular interface template 2 of claim 1, further comprising a gas conduit connecting said first surface 34 and said second surface 36, wherein said gas conduit is configured to supply fuel from said first surface 34 to said second surface 36.

9. A modular interface template 2 configured to receive a plug and play comfort device 18, said modular interface template 2 comprising:
(a) a wall having a first surface 34 and a second surface 36;
(b) an air inlet channel 6 connecting said first surface 34 and said second surface 36, wherein said air inlet channel 6 is configured to enable air flow between said first surface 34 and said second surface 36;
(c) an air outlet channel 8 connecting said second surface 36 and said first surface 34, wherein said air outlet channel 8 is configured to enable air flow between said second surface 36 and said first surface 34;
(d) a water inlet conduit 24 connecting said first surface 34 and said second surface 36, wherein said water inlet conduit 24 is configured to enable water flow from said first surface 34 to said second surface 36;
(e) a water outlet conduit 26 connecting said second surface 36 and said first surface 34, wherein said water outlet conduit 26 is configured to enable water flow from said second surface 36 to said first surface 34; and
(f) at least one electric power conductor 30, 32 connecting said second surface 36 and said first surface 34, wherein said at least one electric power conductor 32 is configured to enable electric power transmission between said second surface 36 and said first surface 34.

10. The modular interface template 2 of claim 9, further comprising a comfort device 18 comprising an air heater 42 configured to receive air flow supplied at said first surface 34 by said air outlet channel 8 and add heat to said air flow and send the air flow to said second surface 36 at said air inlet channel 6.

11. The modular interface template 2 of claim 9, further comprising a comfort device 18 comprising an air chiller 42 configured to receive air flow supplied at said first surface 34 by said air outlet channel 8 and remove heat from said air flow and send the air flow to said second surface 36 at said air inlet channel 6.

12. The modular interface template 2 of claim 9, further comprising a comfort device 18 comprising a water heater 44 configured to receive water flow supplied at said first surface 34 by said water outlet conduit 26 and add heat to the water flow and send the water flow to said second surface 36 at said water inlet conduit 24.

13. The modular interface template 2 of claim 9, further comprising a communication conduit 22 between said first surface 34 and said second surface 36, wherein said communication conduit 22 is configured to receive a communication connection at said first surface 34.

14. The modular interface template 2 of claim 9, further comprising a gas conduit 28 connecting said first surface 34 and said second surface 36, wherein said gas conduit 28 is configured to supply fuel from said first surface 34 to said second surface 36.

15. The modular interface template 2 of claim 9, further comprising a comfort device 18 comprising a humidifier 48 configured to receive a portion of water flow supplied at said first surface 34 by said water outlet conduit 26 and supply moisture derived from the portion of water flow into said air inlet channel 6.

16. A modular interface template 2 configured to receive a plug and play comfort device 18, said modular interface template 2 comprising:
(a) a wall having a first surface 34 and a second surface 36;
(b) an air inlet channel 6 connecting said first surface 34 and said second surface 36, wherein said air inlet channel 6 is configured to enable air flow between said first surface 34 and said second surface 36;
(c) an air outlet channel 8 connecting said second surface 36 and said first surface 34, wherein said air outlet channel 8 is configured to enable air flow between said second surface 36 and said first surface 34;
(d) a water inlet conduit 24 connecting said first surface 34 and said second surface 36, wherein said water inlet conduit 24 is configured to enable water flow from said first surface 34 to said second surface 36;
(e) a water outlet conduit 26 connecting said second surface 36 and said first surface 34, wherein said water outlet conduit 26 is configured to enable water flow from said second surface 36 to said first surface 34; and
(f) a gas conduit 28 connecting said first surface 34 and said second surface 36, wherein said gas conduit 28 is configured to supply fuel from said first surface 34 to said second surface 36.

17. The modular interface template 2 of claim 16, further comprising a comfort device 18 comprising an air heater 42 configured to receive air flow supplied at said first surface 34 by said air outlet channel 8 and add heat to said air flow and send the air flow to said second surface 36 at said air inlet channel 6.

18. The modular interface template 2 of claim 16, further comprising a comfort device 18 comprising an air chiller 42 configured to receive air flow supplied at said first surface 34 by said air outlet channel 8 and remove heat from said air flow and send the air flow to said second surface 36 at said air inlet channel 6.

19. The modular interface template 2 of claim 16, further comprising a comfort device 18 comprising a water heater 44 configured to receive water flow supplied at said first surface 34 by said water outlet conduit 26 and add heat to the water flow and send the water flow to said second surface 36 at said water inlet conduit 24.

20. The modular interface template 2 of claim 16, further comprising a comfort device 18 comprising a humidifier 48 configured to receive a portion of water flow supplied at said first surface 34 by said water outlet conduit 26 and supply moisture derived from the portion of water flow into said air inlet channel 6.
